(19) United States
(12) Patent Application Publication
(10) Pub. No.: US 2022/0321475 A1
(43) Pub. Date: Oct. 6, 2022

(54) METHOD AND APPARATUS FOR ENFORCING PACKET DETECTION RULES

(71) Applicant: NOKIA TECHNOLOGIES OY, Espoo (FI)

(72) Inventors: Laurent THIEBAUT, Antony (FR); Georgios GKELLAS, Petroupoli (GR); Bruno LANDAIS, Pleumeur-Bodou (FR)

(73) Assignee: NOKIA TECHNOLOGIES OY, Espoo (FI)

(21) Appl. No.: 17/223,271

(22) Filed: Apr. 6, 2021

(51) Int. Cl. H04L 12/801; H04L 29/12

(52) U.S. Cl. CPC H04L 47/12; H04L 61/1511; H04L 47/11

(57) ABSTRACT

Techniques for enforcing packet detection rules within communication systems are provided. A network entity may configure a user plane function to detect whether a domain name system request sent by a user equipment satisfies one or more packet detection rules. The network entity may receive, from a user plane function, a report that a domain name system request sent by the user equipment has been detected as non-compliant with instructions sent to the user equipment. The network entity may cause one or more corrective actions relating to traffic offloading.

### TECHNOLOGICAL FIELD

An example embodiment relates generally to wireless communications and, more particularly, but not exclusively, to packet detection rules within such systems.

### BACKGROUND

As the cellular system including the Fifth Generation (5G) system supports an increasing number of devices and services including applications with a wide range of use cases and diverse needs with respect to bandwidth, latency, and reliability requirements, the cellular system may need to prioritize resources across the wireless access network and the core network (and/or for example, prioritizing across the control plane and the user plane) to support differentiation among different services.

### BRIEF SUMMARY

A method, apparatus, and computer program product are disclosed for providing corrective actions when packet detection in the user plane has detected a domain name server request from a user equipment that is not compliant with information sent by the network about the network domain name server that the user equipment should use. In this regard, the method, apparatus and system are configured to take corrective action, which may correspond to inserting in the data path of a data session for the corresponding user equipment a local user plane function, wherein the local user plane function enforces the traffic offloading to edge application servers, and/or of forwarding the DNS request once the local user plane function has been inserted in the data path of the data session. By checking whether the user equipment is following the data traffic rules, the method, apparatus and system may be able to enforce data traffic in a more efficient and accurate manner.

In an example embodiment, a method is provided that includes configuring a user plane function to detect whether a domain name system request sent by a user equipment satisfies one or more packet detection rules. The method also includes receiving, from the user plane function, a report that the domain name system request sent by the user equipment has been detected as non-compliant with instructions sent to the user equipment. The report that is received from the user plane function may include the domain name system request sent by the user equipment. The method further includes causing one or more corrective actions relating to traffic offloading.

In a method of an example embodiment, causing one or more corrective actions may include inserting a local user plane function in the data path of a data session for the corresponding user equipment. In this example embodiment, the local user plane function enforces the traffic offloading to an edge application server. The method of an example embodiment causes one or more corrective actions by forwarding the domain name system request towards a domain name system server once the local user plane function has been inserted in the data path of a data session for the corresponding user equipment. The method of an example embodiment causes one or more corrective actions by forwarding the domain name system request towards an edge application server discovery function corresponding to the instructions sent to the user equipment.

The method of an example embodiment configures a user plane function to detect whether the domain name system request sent by the user equipment satisfies one or more packet detection rules by configuring the user plane function to compare one or more values provided by the domain name system request from the user equipment with one or more values associated with a network domain name system resolver assigned to the user equipment. The one or more values provided by the domain name system request may include a destination internet protocol address and a destination port and the one or more values associated with the network domain name system resolver may include an internet protocol address.

The method of an example embodiment configures a user plane to detect that the domain name system request sent by the user equipment does not comply with the instructions sent earlier to the user equipment by provisioning one packet detection rule to detect traffic matching domain name system requests sent to any internet protocol address other than an internet protocol address of the network domain name system resolver. The method of an example embodiment configures a user plane to detect that the domain name system request sent by the user equipment does not comply with the instructions earlier sent to the user equipment by provisioning at least a first and second packet detection rule. The first packet detection rule is evaluated first by the user plane function and is set to detect traffic matching domain name system requests sent to an internet protocol address of the network domain name system resolver. The second packet detection rule is evaluated only if the packet does not match the first packet detection rule and is set to detect traffic matching domain name system requests sent to any internet protocol address.

The domain name server request may identify any fully qualified domain name. The domain name server request may identify a fully qualified domain name matching some detection criteria.

In an example embodiment, an apparatus is provided including at least one processor and at least one memory including computer program code with the at least one memory and the computer program code configured to, with the at least one processor, cause the apparatus at least to configure a user plane function to detect whether the domain name system request sent by a user equipment satisfies one or more packet detection rules. The at least one memory and the computer program code are further configured to, with the at least one processor, cause the apparatus of the at least one memory and the computer program code configured to, with the at least one processor, cause the apparatus of an example embodiment to receive, from the user plane function, a report that a domain name system request sent by the user equipment has been detected as non-compliant with instructions sent to the user equipment. The report that is received from the user plane function may include the domain name system request sent by the user equipment. The at least one memory and the computer program code are further configured to, with the at least one processor, cause the apparatus of the at least one memory and the computer program code configured to, with the at least one processor, cause the apparatus of an example embodiment to cause one or more corrective actions relating to traffic offloading.

The apparatus of an example embodiment may be configured to cause one or more corrective actions by inserting a local user plane function in a data path of a data session for the corresponding user equipment. The local user plane function of this example embodiment enforces the traffic offloading to an edge application server. The apparatus of an example embodiment is configured to cause one or more corrective actions by forwarding the domain name system request towards a domain name system server once the local user plane function has been inserted in the data path of a data session for the corresponding user equipment. The apparatus of an example embodiment is configured to cause one or more corrective actions by forwarding the domain name system request towards an edge application server discovery function corresponding to the instructions sent to the user equipment.

The apparatus of an example embodiment is caused to configure a user plane function to detect whether the domain name system request sent by the user equipment satisfies one or more packet detection rules by configuring the user plane to compare one or more values provided by the domain name system request with one or more values associated with a network domain name system resolver assigned to the user equipment. In an example embodiment, the one or more values provided by the domain name system request may include a destination internet protocol address and a destination port, and the one or more values associated with the network domain name system resolver may include an internet protocol address.

The apparatus of an example embodiment is caused to configure a user plane function to detect that the domain name system request sent by the user equipment does not comply with the instructions sent earlier to the user equipment by provisioning one packet detection rule to detect traffic matching domain name system requests sent to any internet protocol address other than an internet protocol address of the network domain name system resolver. The apparatus of an example embodiment is caused to configure the user plane function to detect that the domain name system request sent by the user equipment does not comply with the instructions earlier sent to the user equipment by provisioning at least a first and second packet detection rule. The first packet detection rule is evaluated first by the user plane function and is set to detect traffic matching domain name system requests sent to an internet protocol address of the network domain name system resolver. The second packet detection rule is evaluated only if the packet does not match the first packet detection rule and is set to detect traffic matching domain name system requests sent to any internet protocol address.

The domain name server request of an example embodiment may identify any fully qualified domain name. The domain name server request may identify a fully qualified domain name matching some detection criteria.

In an example embodiment, a computer program product is provided that includes at least one non-transitory computer-readable storage medium having computer executable program code instructions stored therein with the computer executable program code instructions including program code instructions configured, upon execution, to configure a user plane function to detect whether the domain name system request sent by a user equipment satisfies one or more packet detection rules. The computer executable program code instructions also include program code instructions are further configured, upon execution, to receive, from the user plane function, a report that a domain name system request sent by the user equipment has been detected as non-compliant with instructions sent to the user equipment. The report received from the user plane function in an example embodiment may include the domain name system request sent by the user equipment. The computer executable program code instructions further include program code instructions are further configured, upon execution, to cause one or more corrective actions relating to traffic offloading.

The program code instructions configured to cause one or more corrective actions in accordance with an example embodiment include program code instructions configured to insert a local user plane function in the data path of a data session for the corresponding user equipment. The local user plane function of this example embodiment enforces the traffic offloading to an edge application server. The program code instructions configured to cause one or more corrective actions in accordance with an example embodiment include program code instructions configured to forward the domain name system request towards a domain name system server once the local user plane function has been inserted in the data path of a data session for the corresponding user equipment. The program code instructions configured to cause one or more corrective actions in accordance with an example embodiment include program code instructions configured to forward the domain name system request towards an edge application server discovery function corresponding to the instructions sent to the user equipment.

The program code instructions of an example embodiment configure a user plane function to detect when the domain name system request sent by the user equipment satisfies one or more packet detection rules by configuring the user plane function to compare one or more values provided by the domain name system request from the user equipment with one or more values associated with a network domain name system resolver assigned to the user equipment. In an example embodiment, the one or more values provided by the domain name system request may include a destination internet protocol address and a destination port, and the one or more values associated with the network domain name system resolver may include an internet protocol address.

The program code instructions of an example embodiment configure a user plane function to detect that the domain name system request sent by the user equipment does not comply with the instructions sent earlier to the user equipment by provisioning one packet detection rule to detect traffic matching domain name system requests sent to any internet protocol address other than an internet protocol address of the network domain name system resolver. The program code instructions of an example embodiment configure a user plane function to detect that the domain name system request sent by the user equipment does not comply with the instructions earlier sent to the user equipment by provisioning at least a first and second packet detection rule. The first packet detection rule is to be evaluated first by the user plane function and is set to detect traffic matching domain name system requests sent to an internet protocol address of the network domain name system resolver. The second packet detection rule is evaluated only if the packet does not match the first packet detection rule and is set to detect traffic matching domain name system requests sent to any internet protocol address.

The domain name server request of an example embodiment identifies any fully qualified domain name. In an example embodiment, the domain name server request identifies a fully qualified domain name matching some detection criteria.

In a further example embodiment, an apparatus is provided that includes means for configuring a user plane function to detect whether the domain name system request sent by a user equipment satisfies one or more packet detection rules. The apparatus further includes means for receiving, from the user plane function, a report that a domain name system request sent by the user equipment has been detected as non-compliant with instructions sent to the user equipment. The report that is received from the user plane function may include the domain name system request sent by the user equipment. The apparatus further includes means for causing one or more corrective actions relating to traffic offloading.

The means for causing one or more corrective actions may include means for inserting a local user plane function in the data path of a data session for the corresponding user equipment. In this example embodiment, the local user plane function enforces the traffic offloading to an edge application server. The means for causing one or more corrective actions may include means for forwarding the domain name system request towards a domain name system server once the local user plane function has been inserted in the data path of a data session for the corresponding user equipment. The means for causing one or more corrective actions may include means for forwarding the domain name system request towards an edge application server discovery function corresponding to the instructions sent to the user equipment.

The means for configuring a user plane function to detect whether the domain name system request sent by the user equipment satisfies one or more packet detection rules includes means for configuring the user plane function to compare one or more values provided by the domain name system request from the user equipment with one or more values associated with a network domain name system resolver assigned to the user equipment. The one or more values provided by the domain name system request may include a destination internet protocol address and a destination port and the one or more values associated with the network domain name system resolver may include an internet protocol address.

The means for configuring a user plane function to detect that the domain name system request sent by the user equipment does not comply with the instructions sent earlier to the user equipment by provisioning one packet detection rule to detect traffic matching domain name system requests sent to any internet protocol address other than an internet protocol address of the network domain name system resolver. The means for configuring a user plane to detect that the domain name system request sent by the user equipment does not comply with the instructions earlier sent to the user equipment by provisioning at least a first and second packet detection rule. The first packet detection rule is evaluated first by the user plane function and is set to detect traffic matching domain name system requests sent to an internet protocol address of the network domain name system resolver. The second packet detection rule is evaluated only if the packet does not match the first packet detection rule and is set to detect traffic matching domain name system requests sent to any internet protocol address.

The domain name server request may identify any fully qualified domain name. The domain name server request may identify a fully qualified domain name matching some detection criteria.

### BRIEF DESCRIPTION OF THE DRAWINGS

Having thus described certain example embodiments of the present disclosure in general terms, reference will hereinafter be made to the accompanying drawings, which are not necessarily drawn to scale, and wherein:

FIG. 1 shows a communication system in an illustrative embodiment;

FIG. 2 is a block diagram of an apparatus that may be specifically configured in accordance with an example embodiment of the present disclosure;

FIG. 3 shows a message flow for an edge application server discovery procedure in an illustrative embodiment;

FIG. 4 illustrates a flow diagram of an embodiment for configuring a network entity to determine whether DNS request satisfies one or more packet detection rules;

FIG. 5 illustrates a flow diagram of an embodiment for determining, by a network entity, whether a DNS request satisfies one or more packet detection rules;

FIG. 6 shows a message flow for session management policy association establishment in an illustrative embodiment in an illustrative embodiment;

FIG. 7 shows a message flow for session management function initiated session management policy association modification in an illustrative embodiment; and

FIG. 8 shows a message flow for policy control function initiated session management policy association modification in an illustrative embodiment.

### DETAILED DESCRIPTION

Some embodiments of the present invention will now be described more fully hereinafter with reference to the accompanying drawings, in which some, but not all, embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information,” and similar terms may be used interchangeably to refer to data capable of being transmitted, received and/or stored in accordance with embodiments of the present invention. Thus, use of any such terms should not be taken to limit the spirit and scope of embodiments of the present invention.

Additionally, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device (such as a core network apparatus), field programmable gate array, and/or other computing device.

Control and User Plane Separation (CUPS) in mobile networks, such as in mobile edge computing (MEC) networks, allows for separation between control plane functions (e.g., connection management, quality of service (QoS) policies, user authentication, etc.) and user plane functions (e.g., data traffic forwarding). More specifically, CUPS decouples packet gateway control and user plane functions that allow the data forwarding component to be decentralized. As such, packet processing and traffic aggregation may be performed closer to the network edge, thereby increasing bandwidth efficiencies while reducing overall network bandwidth.

CUPS may be used to support fifth generation (5G) new radio (NR) implementations to enable internet of things (IoT) applications. MEC systems may connect to a radio access network element, such as a gNB and may provide applications and services to a user equipment (UE) attached to the gNB. The applications and services offered by the MEC server may be provided by different service providers. For example, a UE may transmit a domain name server (DNS) request, or DNS query, related to a MEC server. The DNS request may comprise an internet protocol (IP) address associated with the domain name server.

A received DNS query sent by the UE may be handled by an edge application server discovery function (EASDF) by first completing a packet data unit (PDU) session establishment procedure, in which a session management function (SMF) selects an EASDF and provides the EASDF address to the UE as the DNS server to be used for the PDU session. The SMF may also configure the EASDF with DNS message handling rules to forward DNS messages of the UE and/or report when detecting DNS messages from a UE. However, the UE may not always transmit the DNS request to the EASDF selected by the SMF. This may result in the EASDF being unable to operate and thus, traffic offloading may not be possible for the data session. The UE may not always transmit the DNS request to the EASDF selected by the SMF, which may be due to the fact that the application in the UE has its own pre-programmed mechanisms related with DNS usage and with the DNS server to use.

Therefore, it may be beneficial to detect data packets, such as the DNS request, arriving at a network entity, such as a user plane function (UPF), and utilize one or more packet detection rules (PDRs) to classify the data packet. In some example embodiments, each PDR is used to detect data packets in a certain transmission direction, such as the uplink (UL) direction or downlink (DL) direction. Further, PDR may comprise PDR filters, or service data flow (SDF) filters. In some example embodiments, the SDF filters may correspond to an “AND” operation such that the filter matches when all elements in the SDF filter match. In some embodiments, multiple SDF filters may be used, which may correspond to an “OR” operation such that there is a match if any SDF filter matches. In some embodiments, multiple SDF filters may be used, which may correspond to a “NOT” operation, such as A and NOT(B), such that there is a match if the data packet contains some information at protocol layer A and does not contain some information at protocol layer B. In another embodiment multiple PDR may be used as follows: A first PDR1 that has a higher priority and whose traffic filter targets (DNS port 53 or 853) and the IP address of the EASDF while a second PDR2 that has a lower priority, and whose traffic filter targets (DNS port 53 or 853) and the any IP address. A packet matching PDR2 is a packet that does not match PDR1 thus a DNS request sent to a DNS server that is not the EASDF. Using such PDR filters allows for data packets arriving at a network entity, such as a UPF, to be classified. A network entity, such as a SMF, may configure the network entity, such as a UPF, with one or more PDRs such that the network entity may detect non-compliant data packets. The network entity, such as a UPF, may be further configured to forward the non-compliant data packets to the appropriate network entity, e.g. to the EASDF. For example, if a data packet arrives at a UPF, UPF may determine the data packet satisfies one or more PDRs (e.g. the data packet is non-compliant), and the UPF may notify a corresponding SMF. The SMF may insert a local UPF in the data path of a data session for the DNS request from a UE and the local UPF may be configured to enforce traffic offloading to an edge application server (EAS). In some embodiments, the SMF may also forward the DNS request to the local UPF. As another example, if the data packet arrives at a UPF, the UPF may determine the data packet does not satisfy one or more PDRs (e.g. the data packet is compliant), the UPF may forward the data packet to the correct DNS resolver as described in the DNS request from the UE.

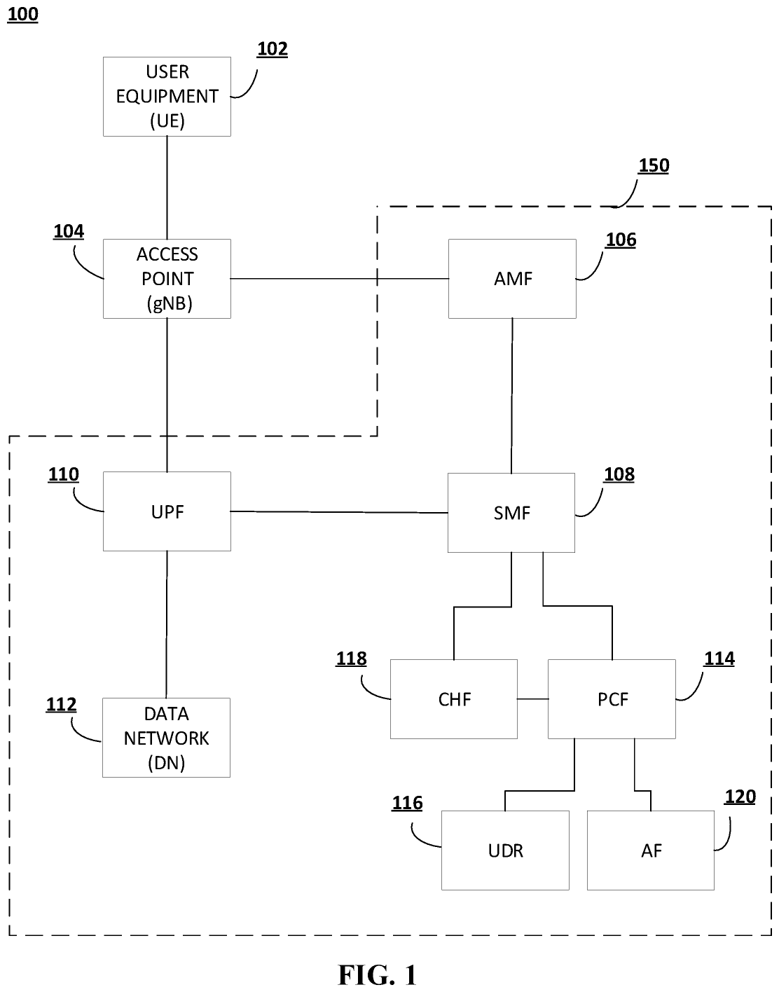

FIG. 1 shows a communication system 100 within which illustrative embodiments are to be implemented. However, it is to be appreciated that embodiments are not limited to the network configurations illustrated herein or otherwise described below. It is to be understood that the elements shown in communication system 100 are intended to represent main function provided within the system. As such, the blocks shown in FIG. 1 reference specific elements in 5G networks that provide the main functions. However, other network elements may be used to implement some or all of the main functions represented. Also, it is to be understood that not all functions of a 5G network are depicted in FIG. 1. Rather, functions that facilitate an explanation of illustrative embodiments are represented.

By way of example, the communication system 100 may be deployed within a radio access architecture based on NR. However, the system may be deployed in other applications including within other communication networks including, for example, long term evolution advanced (LTE Advanced, LTE-A), a universal mobile telecommunications system (UMTS) radio access network (UTRAN or E-UTRAN), wireless local area network (WLAN or WiFi), worldwide interoperability for microwave access (WiMAX), Bluetooth®, personal communications services (PCS), ZigBee®, wideband code division multiple access (WCDMA), systems using ultra-wideband (UWB) technology, sensor networks, mobile ad-hoc networks (MANETs) and Internet Protocol multimedia subsystems (IMS) or any combination thereof. Any Access network eligible to access to the 5G Core such as the Un-trusted Non 3GPP access terminated at a N3IWF, the trusted Non 3GPP access terminated at a TNGF or a Wireline access terminated at a W-AGF may be used instead of the NG RAN/gNB;

In the radio access architecture of FIG. 1, user equipment 102 is configured to be in a wireless connection on one or more communication channels in a cell with an access node, such as a gNB. The physical link from a user equipment 102 to a gNB is called the uplink or reverse link and the physical link from the gNB to the UE is called the downlink or forward link. It should be appreciated that the gNBs or their functionalities may be implemented by using any node, host, server or access point (AP), etc. entity suitable for such a usage.

A communications system typically comprises more than one gNB, in which case the gNBs may also be configured to communicate with one another over links, wired or wireless, designed for the purpose. These links may be used for signaling purposes. The gNB is a computing device configured to control the radio resources of the communication system to which the gNB is coupled. The gNB may also be referred to as a base station, an access point or any other type of interfacing device including a relay station capable of operating in a wireless environment. The gNB includes or is coupled to transceivers. From the transceivers of the gNB, a connection is provided to an antenna unit that establishes bi-directional radio links to UEs. As such, the transceivers of the gNB and the transceivers of the UEs may include transmitters and receivers configured to communicate via a channel. The gNB of this example embodiment is further connected to core network 150 (5G core network 5GC or next generation core NGC).

Accordingly, as shown, communication system 100 comprises UE 102 that communicates, such as via an air interface or N1 interface, with an access point (gNB) 104. The UE 102 may be a mobile station, and such a mobile station may comprise, by way of example, a mobile telephone, a computer, or any other type of communication device. In an LTE-V2X implementation, one or more UEs may deployed in a given vehicle. The term “user equipment” as used herein is therefore intended to be construed broadly, so as to encompass a variety of different types of mobile stations, subscriber stations or, more generally, communication devices, including examples such as a combination of a data card inserted in a laptop or other equipment (e.g., a vehicle). The user equipment 102 may also refer to a portable computing device that includes wireless mobile communication devices operating with or without a subscriber identification module (SIM), including, but not limited to, the following types of devices: a mobile station (mobile phone), smartphone, personal digital assistant (PDA), handset, device using a wireless modem (alarm or measurement device, etc.), laptop and/or touch screen computer, tablet, game console, notebook, and multimedia device. It should be appreciated that a UE may also be a nearly exclusive uplink only device, of which an example is a camera or video camera loading images or video clips to a network. A UE may also be a device having the capability to operate in an IoT network, which is a scenario in which objects are provided with the ability to transfer data over a network without requiring human-to-human or human-to-computer interaction. The user equipment (or in some embodiments a layer 3 relay node) is configured to perform one or more of user equipment functionalities. The user equipment may also be called a subscriber unit, mobile station, remote terminal, access terminal, user terminal or user device just to mention but a few names or apparatuses.

In one embodiment, UE 102 is comprised of a Universal Integrated Circuit Card (UICC) and Mobile Equipment (ME). The UICC is the user-dependent part of the UE and contains at least one Universal Subscriber Identity Module (USIM) and appropriate application software. The USIM securely stores the International Mobile Subscriber Identity (IMSI) number and its related key, which are used to identify and authenticate subscribers to access networks. The ME is the user-independent part of the UE and contains terminal equipment (TE) functions and various mobile termination (MT) functions.

The access point 104 is illustratively part of a radio access network (RAN), or multi-access edge computing radio access network (MEC-RAN), of the communication system 100. Such an access network may comprise, for example, an 5G System having a plurality of base stations and one or more associated radio network control functions. The base stations and radio network control functions may be logically separate entities, but in a given embodiment may be implemented in the same physical network element, such as, for example, a base station router or femto cellular access point, such as a gNB. In some example embodiments, the access point 104 may be in communication with a user plane function (UPF) 110, such as via the N9 interface.

In some example embodiments, the access point 104 is operatively coupled to an Access and Mobility Management Function (AMF) 106. An AMF 106, as used herein, is the element or function in the 5GC part 150 of the communication system 100 that manages, among other network operations, access and authentication operations with the UE (through the access point 104).

In some example embodiments, the AMF 106 is operatively coupled to a session management function (SMF) 108, such as via the N11 interface. In some example embodiments, the SMF 108 may be chosen by the AMF 106, such as by querying an associated network repository function (NRF). A SMF 108, as used herein, is the element or function in the 5GC part 150 of the communication system 100 that provides PDU session management, IP address allocation general packet radio service tunneling protocol user plane (GTP-U) management, and downlink notification management. In some example embodiments, SMF 108 may select an appropriate UPF 110 during the setup of a PDU session. Selection for the appropriate UPF may depend on the UPF load, geographic location, PDU session type, etc. In some example embodiments, SMF 108 may also select an appropriate policy control function (PCF) 114 during the setup of the PDU session. The selection may depend on the data network name used by the PDU session. In some example embodiments, SMF 108 may provide support for interfacing with a charging function (CHF) 118 for both online charging systems (OCS) and offline charging systems (OFCS).

SMF 108 may manage (e.g., create, update, remove, etc.) PDU sessions and manage session context with a UPF 110, such as via the N4 interface. In some example embodiments, the parameters over the N4 interface provided from SMF 108 to UPF 110 may comprise an N4 Session ID. In some example embodiments, the parameters may also comprise one or more PDRs to classify data traffic, e.g., one or more DNS requests, arriving at the UPF 110.

In some example embodiments, the UPF 110 may provide PDU routing and forwarding. For example, UPF 110 may perform the role of an UL classifier by directing data flows to specific data networks (DN) based at least in part on traffic matching filters. In some example embodiments, UPF 110 may be used to detect issues resulting from UE 102. For example, the UPF 110 may determine whether a DNS request from UE 102 satisfies a network DNS resolver as configured by SMF 108 by using one or more configured PDRs.

In some example embodiments, SMF 108 is operatively coupled to policy control function (PCF) 114, such as via the N7 interface. In some example embodiments, the PCF 114 may provide policy control decision and traffic flows based on charging control functionalities. For example, the PCF 114 may provide (e.g., send, transmit, etc.) policy rules for application and service data flow detection, gating, quality of service (QoS) and flow based charging to SMF 108.

In some example embodiments, the PCF 114 is operatively coupled to a unified data repository (UDR) 116, such as via the Nudr interface. The UDR 116 may contain subscription-related information, such as subscription data, policy data, application data, and structured data for exposure. In some example embodiments, data stored at the UDR 116 is made available through various network functions, such as, policy data is made available to SMF 108 through PCF 114.

In some example embodiments, PCF 114 is operatively coupled to an application function (AF) 120. The AF 120 may perform operations such as retrieving resources, policy control, and exposing services to end users of UE 102.

In some example embodiments, SMF 108 may be operatively coupled to a charging function (CHF) 118, such as via the Nchf interface. In some example embodiments, CHF 118 may also be operatively coupled to PCF 114, such as via the N28 interface. The CHF 118 may provide charging services to be offered to authorized network functions, such as to PCF 114 and/or SMF 108. In some example embodiments, CHF 118 may provide access to an associated billing system. In some example embodiments, CHF 118 may include a charging gateway function (CGF), account balance management function (ABMF), and rating function (RF).

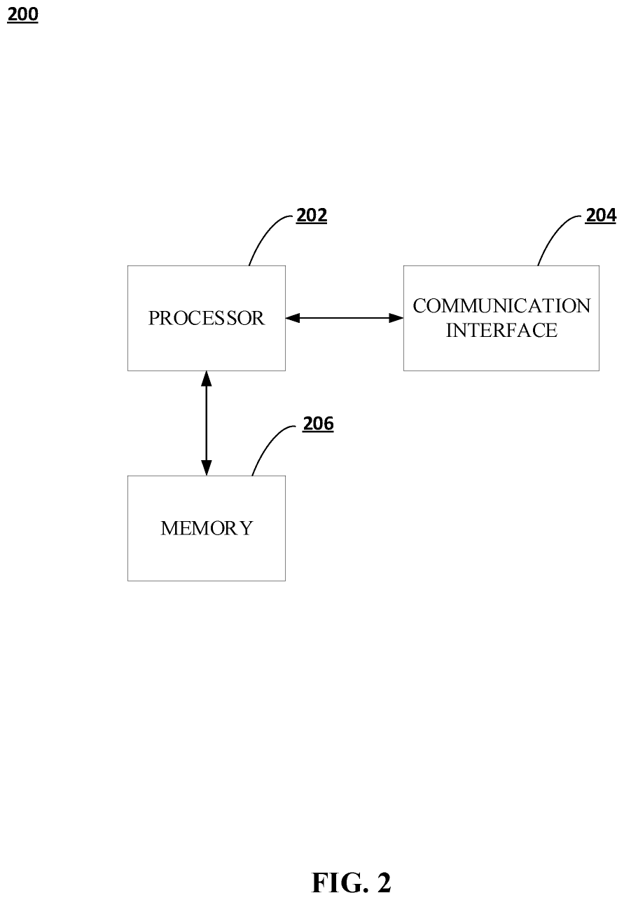

One example of an apparatus 200 that may be configured to function as a network entity, such as UPF 110, SMF 108, and/or PCF 114, is depicted in FIG. 2. As shown in FIG. 2, the apparatus 200 includes, is associated with or is in communication with processing circuitry 202, a memory 206 and a communication interface 204. The processing circuitry 202 may be in communication with the memory device via a bus for passing information among components of the apparatus 200. The memory device 206 may be non-transitory and may include, for example, one or more volatile and/or non-volatile memories. In other words, for example, the memory device 206 may be an electronic storage device (e.g., a computer readable storage medium) comprising gates configured to store data (e.g., bits) that may be retrievable by a machine (e.g., a computing device like the processing circuitry). The memory device 206 may be configured to store information, data, content, applications, instructions, or the like for enabling the apparatus to carry out various functions in accordance with an example embodiment of the present disclosure. For example, the memory device 206 could be configured to buffer input data for processing by the processing circuitry 202. Additionally or alternatively, the memory device 206 could be configured to store instructions for execution by the processing circuitry 202.

The apparatus 200 may, in some embodiments, be embodied in various computing devices as described above. However, in some embodiments, the apparatus may be embodied as a chip or chip set. In other words, the apparatus may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The apparatus may therefore, in some cases, be configured to implement an embodiment of the present invention on a single chip or as a single “system on a chip.” As such, in some cases, a chip or chipset may constitute means for performing one or more operations for providing the functionalities described herein.

The processing circuitry 202 may be embodied in a number of different ways. For example, the processing circuitry 202 may be embodied as one or more of various hardware processing means such as a coprocessor, a microprocessor, a controller, a digital signal processor (DSP), a processing element with or without an accompanying DSP, or various other circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processing circuitry may include one or more processing cores configured to perform independently. A multi-core processing circuitry may enable multiprocessing within a single physical package. Additionally or alternatively, the processing circuitry may include one or more processors configured in tandem via the bus to enable independent execution of instructions, pipelining and/or multithreading.

In an example embodiment, the processing circuitry 202 may be configured to execute instructions stored in the memory device 206 or otherwise accessible to the processing circuitry 202. Alternatively or additionally, the processing circuitry may be configured to execute hard coded functionality. As such, whether configured by hardware or software methods, or by a combination thereof, the processing circuitry may represent an entity (e.g., physically embodied in circuitry) capable of performing operations according to an embodiment of the present disclosure while configured accordingly. Thus, for example, when the processing circuitry is embodied as an ASIC, FPGA or the like, the processing circuitry may be specifically configured hardware for conducting the operations described herein. Alternatively, as another example, when the processing circuitry 202 is embodied as an executor of instructions, the instructions may specifically configure the processor to perform the algorithms and/or operations described herein when the instructions are executed. However, in some cases, the processing circuitry 202 may be a processor of a specific device (e.g., an image or video processing system) configured to employ an embodiment of the present invention by further configuration of the processing circuitry by instructions for performing the algorithms and/or operations described herein. The processing circuitry 202 may include, among other things, a clock, an arithmetic logic unit (ALU) and logic gates configured to support operation of the processing circuitry.

The communication interface 204 may be any means such as a device or circuitry embodied in either hardware or a combination of hardware and software that is configured to receive and/or transmit data, including media content in the form of video or image files, one or more audio tracks or the like. In this regard, the communication interface 204 may include, for example, an antenna (or multiple antennas) and supporting hardware and/or software for enabling communications with a wireless communication network. Additionally or alternatively, the communication interface may include the circuitry for interacting with the antenna(s) to cause transmission of signals via the antenna(s) or to handle receipt of signals received via the antenna(s). In some environments, the communication interface may alternatively or also support wired communication. As such, for example, the communication interface may include a communication modem and/or other hardware/software for supporting communication via cable, digital subscriber line (DSL), universal serial bus (USB) or other mechanisms.

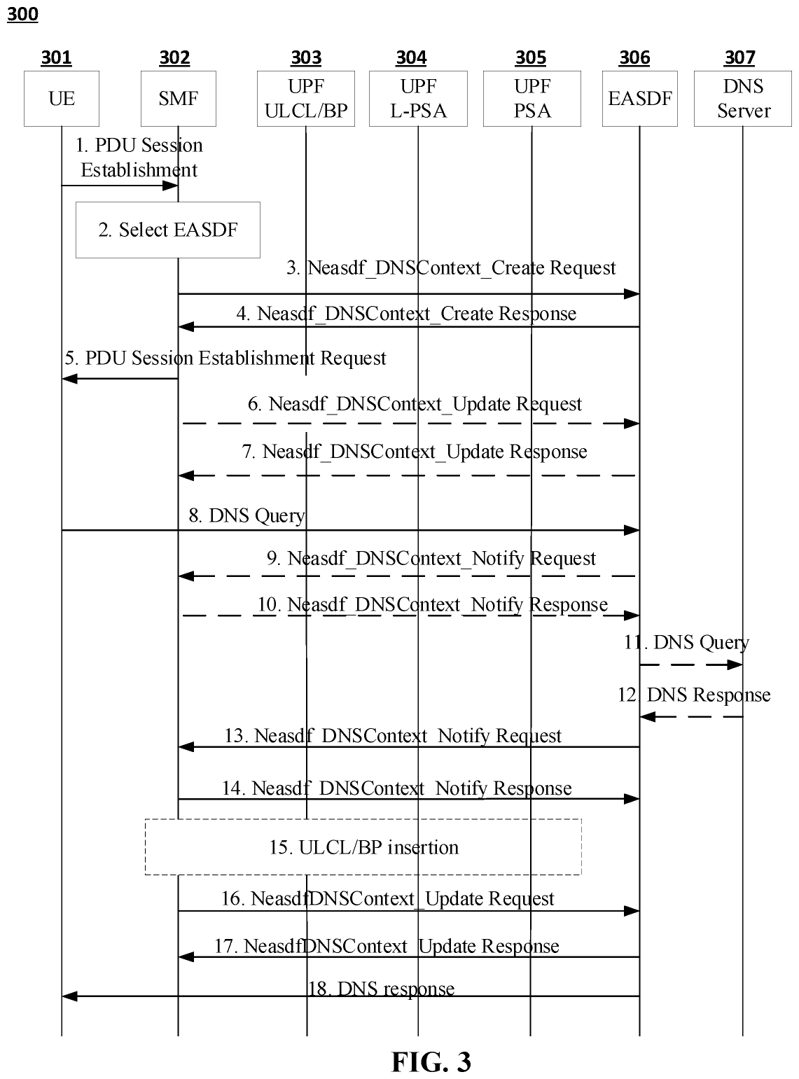

Referring now to FIG. 3, the operations 300 performed for edge application server discovery over a session breakout connectivity model will be discussed herein.

At operation 1, a UE 301 may send a PDU session establishment request to the SMF 302. At operation 2, the SMF 302 may select an EASDF 306, e.g., network DNS resolver, for the UE 301. In some example embodiments, SMF 302 may select EASDF 306 based on the SMF's 302 local configuration or the SMF 302 may select an EASDF registered on a network function repository function (NRF).

At operation 3, the SMF may provide (e.g., send, transmit, etc.) a message to the selected EASDF 306 for example, by invoking a Neasdf_DNSContext_Create Request service operation. In some embodiments, the message may comprise the UE IP address, callback uniform resource identifier, and rules to handle DNS messages from the UE. In some embodiments, the rules to handle DNS messages from the UE may include one or more DNS message forwarding rules and/or DNS message reporting rules. In response, the EASDF 306 may create a DNS context for the PDU session. The DNS context may store the UE IP address, callback URI, and rules to handle DNS messages from the UE.

At operation 4, the EASDF 306 may provide (e.g., send, transmit, etc.) a message to SMF 302 comprising the IP address of the EASDF 306, for example, by invoking the service operation Neasdf_DNSContext_Create. The message may comprise the address, such as an IP address, which is to be used by the UE 301 to reach the EASDF 306 as a DNS server for the PDU session.

At operation 5, the SMF 302 may provide (e.g., send, transmit, etc.) the IP address of the EASDF 306 as the DNS server for the UE 301 in the PDU session establishment accept message. As such, the UE 301 may be configured with the EASDF 306 as the DNS server for the PDU session. The selected IP address of the EASDF 306 is the IP address of the network DNS resolver the UE is assigned and as such, to which DNS requests should be sent.

At operation 6, the SMF 302 may send a message to EASDF 306 to update the PDU session context, such as by invoking Neasdf_DNSContext_Update request. The update message may provide the EASDF 306 with a new PDU session context ID and/or rules to handle DNS queries from UE 301. In some embodiments, SMF 302 may provide this update to EASDF 306 when SMF 302 is triggered by UE mobility, such as when the UE 301 moves to a new location. In some embodiments, the SMF 302 may be triggered by a reporting from EASDF 306 of a DNS Query with certain fully qualified domain name (FQDN). In some embodiments, the SMF 302 may be triggered by the insertion and/or removal of a local PDU session anchor (PSA). At operation 7, the EASDF 306 provides (e.g., send, transmit, etc.) a response to the SMF 302, such as by invoking a Neasdf_DNSContext_Update response.

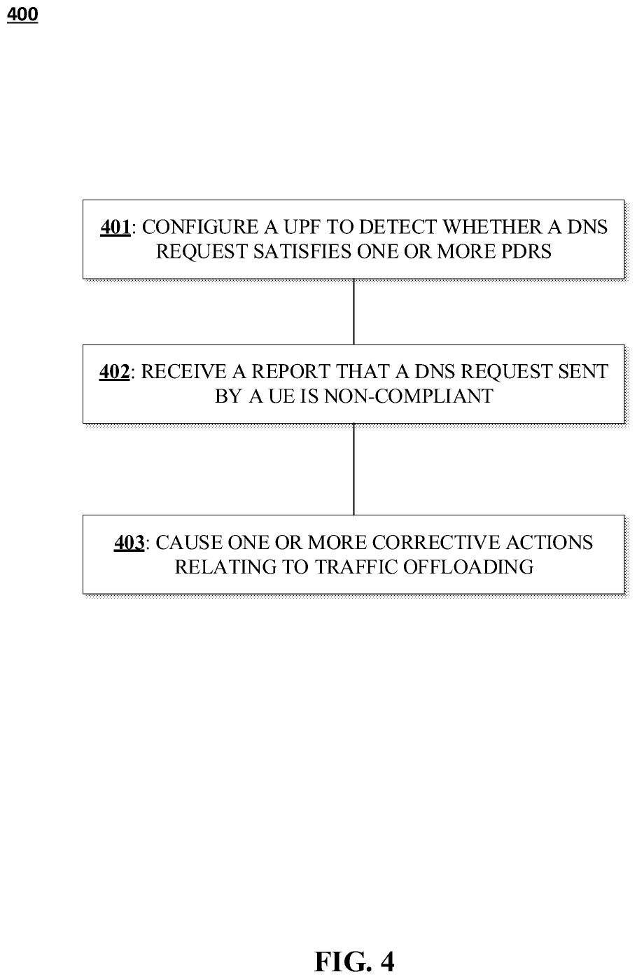

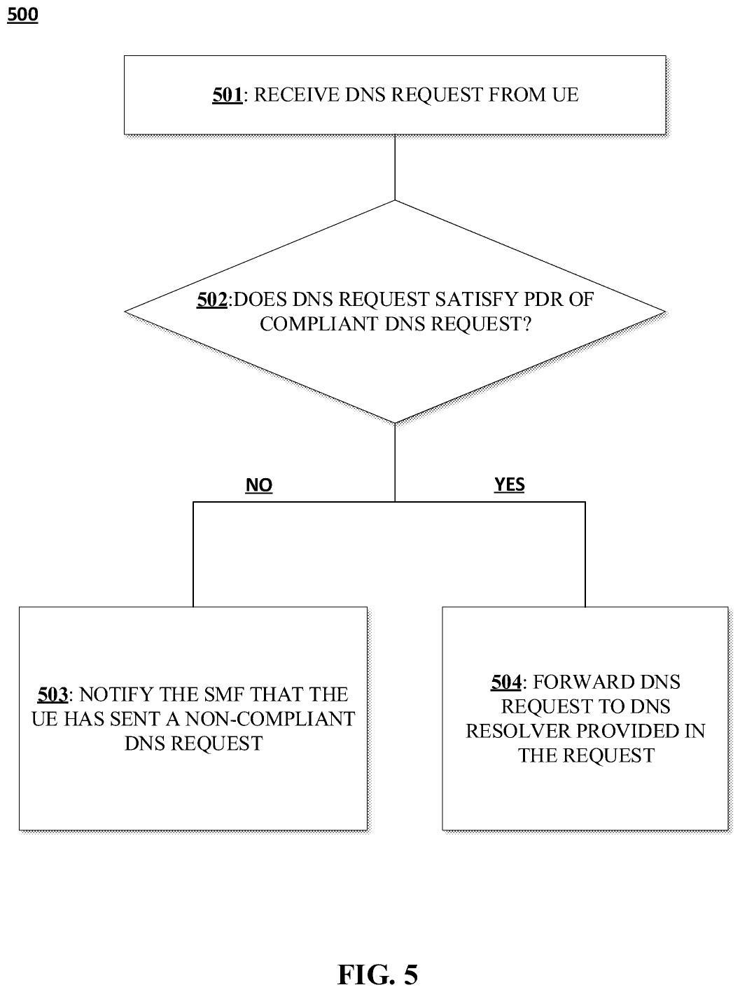

At operation 8, the UE provides a DNS query message to the EASDF 306. The DNS query message may comprise a destination IP address and destination port. As will be discussed in greater detail with respect to FIGS. 4 and 5, the SMF 302 may instruct a UPF, such as UPF 303, 304, and/or 305, to detect DNS traffic. Specifically, the UPF may detect DNS traffic that is not targeting the EASDF's IP addressed as provided by the SMF 302 with regard to operation 5, such as by utilizing the previously described NOT operation PDR.

At operation 9, EASDF 306 may provide a message to SMF 302 if the DNS query matches the DNS message reporting condition for the UE as previously configured by SMF 302, such as by invoking a Neasdf_DNSContext_Notify request. At operation 10, the SMF 302 may provide a message to EASDF 306 in response. In some example embodiments, the response message from SMF 302 may comprise a corresponding edge configured server (ECS). In some example embodiments, the response message from SMF 302 may comprise a corresponding DNS Server IP address. As such, EASDF 306 may be instructed to forward the DNS query to a pre-configured DNS resolver.

At operation 11, the EASDF 306 may handle the DNS query message received from UE 301. In some example embodiments, the EASDF 306 may add the ECS option into the DNS query message and send the DNS query message to a central DNS (C-DNS) server. In some example embodiments, the EASDF 306 may send the DNS query to a local DNS server. In some embodiments, if the EASDF 306 did not receive a reporting and/or forwarding rule from SMF 302 matching the requested FQDN described in the DNS query, the EASDF 306 may forward the DNS query to a pre-configured DNS server. At operation 12, the DNS server 307 that received the DNS query message from EASDF 306 may provide a DNS response message to EASDF 306, indicating the DNS response may be sent to the UE 301.

In operation 13, the EASDF 306 may provide (e.g., send, transmit, etc.) a message to SMF 302 notifying the SMF 302 of the DNS response, such as by invoking a Nesasf_DNSContext_Notify service operation. The message may comprise the EAS information. At operation 14, the SMF 302 may respond to the message from EASDF 306, such as by invoking a Neasdf_DNSContext_Notify Response service operation.

At operation 15, the SMF 302 may perform an uplink classifier (UL CL) and/or branching point (BP) and local PSA selection and/or insert a UL CL/BP and local PSA. In some example embodiments, the SMF 302 may perform this selection based at least in part on the EAS information received from the EASDF 306.

At operation 16, SMF 302 may provide the DNS response indication to EASDF 306, such as by invoking the Neasdf_DNSContext_Update request. At operation 17, the EASDF 306 may respond to the message from SMF 302, such as by invoking a Neasdf_DNSContext_Update response. At operation 18, the EASDF 306 may send the DNS response to UE 301.

Referring now to FIG. 4, an example flowchart 400 implemented, for example, by an apparatus 200 embodied by a network entity, such as by SMF 108, to configure a network entity, such as a UPF 110, to detect whether a DNS request satisfies one or more PDRs.

As shown in block 401, the apparatus 200 embodied by a network entity, such as SMF 108, may include means, such as the processor 202 or the like, for configuring a UPF 110 to detect whether a DNS request satisfies one or more PDRs. In some embodiments, the SMF 108 may configure the UPF 110 to compare one or more values provided by a received DNS request from a UE with one or more values associated with a network DNS resolver assigned to the UE 102 by SMF 108. The one or more values provided by the domain name system request may include a destination internet protocol address and a destination port and the one or more values associated with the network domain name system resolver may include an internet protocol address. In some embodiments, the SMF 108 may further configure the UPF 110 to notify the SMF 108 in the event UPF 110 receives a non-compliant DNS request sent by a UE 102.

In some example embodiments, the SMF 108 may configure the UPF 110 with one or more PDRs. The one or more PDRs may include multiple SDF filters. The SDF filters may correspond to a “NOT” operation, such as A and NOT(B), such that there is a match if the data packet contains some information at protocol layer A and does not contain some information at protocol layer B. In order to for the SMF 108 to configure the UPF 110 in an example embodiment, the UPF 110 may be configured to monitor received DNS requests. In some embodiments, the SMF 108 may configure the UPF 110 with the assigned DNS resolver for UE 102. In some embodiments, the DNS request received by UFP 110 may include a DNS resolver IP address. Based on the reception of either 1) the destination IP address from a DNS request sent by the UE 102 that is not the DNS resolver IP address configured by the SMF 110 or 2) a PFCP notification that the UE 102 has sent DNS requests whose destination IP address is not the DNS resolver IP address configured by the SMF 108, the UPF 110 may notify the SMF 108.

As shown in block 402, the apparatus 200 embodied by a network entity, such as SMF 108, may include means, such as the processor 202, the communication interface 204 or the like, for receiving, from a network entity such as UPF 110, a report that a DNS request sent by a UE 102 has been detected as non-compliant with instructions sent to the UE 102. In some embodiments, the SMF 108 may configure UPF 110, to monitor DNS request traffic. The SMF 108 may configure the network entity with one or more PDRs over the N4 interface. In some embodiments, SMF 108 configures UPF 110 prior to the arrival of DNS requests from UE 102. The SMF 108 of an example embodiment may configure UPF 110 with the one or more PDRs through a packet forwarding control protocol (PFCP) session establishment request and/or a PFCP session modification request. As previously mentioned, the one or more PDRs may be used to classify the data packet arriving at UPF 110 and may include PDR filters, or SDF filters. In some example embodiments, the SDF filters may correspond to an “AND” operation such that the filter matches when all elements in the SDF filter match. Multiple SDF filters may be used, which may correspond to an “OR” operation such that there is a match if any SDF filter matches. In some embodiments, multiple SDF filters may be used, which may correspond to a “NOT” operation, such as A and NOT(B), such that there is a match if the data packet contains some information at protocol layer A and does not contain some information at protocol layer B.

In some example embodiments, SMF 108 may configure UPF 110 to detect whether a DNS request is for a well-known or other predefined DNS port, e.g., 53 plain DNS or 853 DNS over transport layer security (TLS), and if the DNS request includes the correct DNS server address, e.g., the address assigned to the corresponding UE 102 by the SMF 108. Here, protocol layer A may be the destination port and protocol layer B may be the data packet to the correct DNS server address. In the instance that a data packet comprises a well-known DNS port, but does not include the correct DNS server address as previously assigned by the SMF 108, the “NOT” operation condition is satisfied, e.g. the DNS is non-compliant with instructions sent to the UE, and SMF 108 may receive a report from UPF 110 indicating the UE's 102 non-compliance. In the instance that a data packet comprises a well-known DNS port and includes the correct DNS server address as previously assigned by the SMF 108, the “NOT” operation condition is not satisfied, e.g. the DNS is compliant with instructions sent to the UE.

In some example embodiments, the received report may include the DNS request sent by the UE 102, such that the SMF 108 may determine the incorrect DNS resolver address attempted to be used by the UE 102.

In some embodiments, the filtering rule to detect DNS request identifies any FQDN (applies only to IP addresses and transmission control protocol/user datagram protocol (TCP/UPD) ports). In some other embodiments, the filtering rule to detect DNS request identifies also whether the FQDN target of the DNS request is matching some detection criteria such as the FQDN is contain some text pattern, e.g. “example.com”.

As shown in block 403, the apparatus 200 embodied by a network entity, such as SMF 108, may include means, such as the processor 202, the communication interface 204 or the like, to cause one or more corrective actions relating to traffic offloading. The one or more corrective actions relating to traffic offloading may include inserting a local UPF in the data path of a data session for the corresponding UE 102. In some embodiments, the local UPF may enforce traffic offloading to an EAS. This insertion of a local user plane function, and the enforcement by the local user plane function of traffic offloading to edge application servers may not be related with actual traffic to be offloaded (as would have happen when EASDF would have been used) but ensures that as soon as the UE starts an application whose traffic may be offloaded, offloading is provided. Additionally or alternatively, the one or more corrective actions may include forwarding the DNS request to the local UPF once the local UPF has been inserted in the data path of a data session for the corresponding UE 102. In this way, the SMF 108 may correct for the non-compliant DNS request from the UE 102 by offloading the violating data packet to a local UPF, which may enforce the traffic offloading to an EAS. As another type of corrective action, the SMF 108 may decide not to insert immediately a local user plane function, that can enforce traffic offloading to edge application servers, but to forward the DNS request of the UE to the EASDF after having configured the EASDF with the address of the DNS server used by the UE when sending its DNS request. In this way, the SMF 108 may configure the UPF 110 such that the communication network enforces one or more configured PDRs. As yet another type of corrective action, the SMF 108 may forward the DNS request towards an EASDF corresponding to the instructions sent to the user equipment 102 by SMF 108.

Referring now to FIG. 5, an example flowchart 500 implemented, for example, by an apparatus 200 embodied by a network entity, such as by UPF 110, to determine if a DNS request from a UE follows one or more PDRs will be discussed herein.

As shown in block 501, the apparatus 200 embodied by a network entity, such as UPF 110, may include means, such as the processor 202, the communication interface 204 or the like, for receiving a DNS request from a UE 102. In some embodiments, this request may be a DNS query as described with respect to operation 8 of FIG. 3. In some embodiments, the UE 102 may have previously completed the PDU session establishment with the SMF 108 such that the UE 102 is configured with an IP address of the EASDF 306 as the DNS server. The DNS request may include a destination port, such as destination port 53 or 853. The DNS request may also comprise a DNS server address. For example, the DNS request may include a destination IP address corresponding to a DNS resolver.

In some embodiments, the SMF 108 may request the network entity, such as UPF 110, to monitor DNS request traffic. In some embodiments, SMF 108 may configure the network entity with one or more PDRs over the N4 interface. In some embodiments, SMF 108 configures UPF 110 prior to the arrival of DNS requests from UE 102. In some embodiments, SMF 108 may configure UPF 110 with the one or more PDRs through a packet forwarding control protocol (PFCP) session establishment request and/or a PFCP session modification request. As previously mentioned, the one or more PDRs may be used to classify the data packet arriving at UPF 110 and may comprise PDR filters and/or SDF filters.

As shown in block 502, the apparatus 200 embodied by the network entity, such as UPF 110, may include means, such as the processor 202 or the like, for determining whether the DNS request from the UE 102 satisfies one or more PDRs of a compliant DNS request. In some embodiments, the network entity may be configured by SMF 108 to monitor the DNS traffic. In some embodiments, the network entity, such as UPF 110, may be configured to detect that the DNS request sent by the UE 102 does not comply with the instructions sent earlier to the UE 102 by provisioning one packet detection rule to detect traffic matching DNS requests sent to any IP address other than an IP address of the network DNS resolver, as configured by SMF 108. In some embodiments, the one or more PDRs may comprise a first PDR, i.e. PDR1, and a second PDR, i.e. PDR2. In some embodiments, PDR1 may have a higher priority and a traffic filter set to detect traffic matching domain name system requests sent to an internet protocol address of the network domain name system resolver. For example, PDR1 may target a destination DNS port 53 or 853 and the IP address of the EASDF provided by SMF 108 to UE 102. In some embodiments, PDR2 has a lower priority such that PDR2 will be evaluated by the UPF 110 only for data packets that do not match any higher priority PDR, such as PDR1. In some embodiments, PDR2 is set to detect traffic matching DNS requests sent to any internet protocol address. For example, PDR2 may target a destination DNS port 53 or 583 and any IP address. A packet matching PDR2 is a packet that does not match PDR1, and thus corresponds to a DNS request sent by UE 102 to a DNS server that is not the EASDF assigned by the SMF 108 and is therefore a a non-compliant DNS request.

At block 503, the apparatus 200 embodied by the network entity, such as UPF 110, may include means, such as the processor 202, the communication interface 204 or the like, for notifying the SMF 108 that UE 102 is not following the SMF guidance and is using a network DNS resolver not assigned by the SMF 108 in the event the UPF 110 determines the DNS request does not satisfy one or more PDRs of a compliant DNS request. In some example embodiments, the apparatus embodied by the UPF 110, such as the processor, may be configured to provide (e.g., send, transmit, etc.) an event report to the SMF 108, such as over interface N4. In some embodiments, the apparatus embodied by the UPF 110, such as the processor, may be configured to indicate the protocol information elements, such as the values of the destination IP address and destination port as received from the UE 102. As such, SMF 108 may be informed of the exact destination IP address the UE 102 is using. In other embodiments the UPF may in this case forward the DNS request received from the UE to SMF, and this forwarding corresponds to a notification that the UE has issued a DNS request towards a DNS server different from the one that the SMF had configured. In some embodiments, this notification may cause SMF 108 to take one or more corrective actions. The one or more corrective actions may involve data traffic configuration and/or reconfiguration. For example, the one or more corrective actions taken by SMF 108 may be to install a local UPF to enforce traffic offloading, regardless of whether the UE 102 is starting access to the EAS provided in the DNS request.

In some embodiments, the UPF 110 may be configured by the SMF 108 to enforce one of following actions: 1) forward DNS requests sent by the UE 102, whose destination IP address is not the DNS resolver IP address configured by the SMF 108, e.g. is non-compliant, to the SMF 108, or 2) to discard the DNS requests that are sent by the UE 102, whose destination IP address is not the DNS resolver IP address configured by the SMF, e.g. is non-complaint, and to notify the SMF 108, such as over PFCP, that the UE is using a wrong DNS resolver.

At block 504, the UPF 110 may be configured by the SMF 108 to forward, without any further action, the DNS request sent by the UE 102 to the DNS resolver IP address that the SMF 108 has configured on the UE 102 and in a PDR filter in the event the UPF 110 determines the DNS request satisfies one or more PDRs of a compliant DNS request.

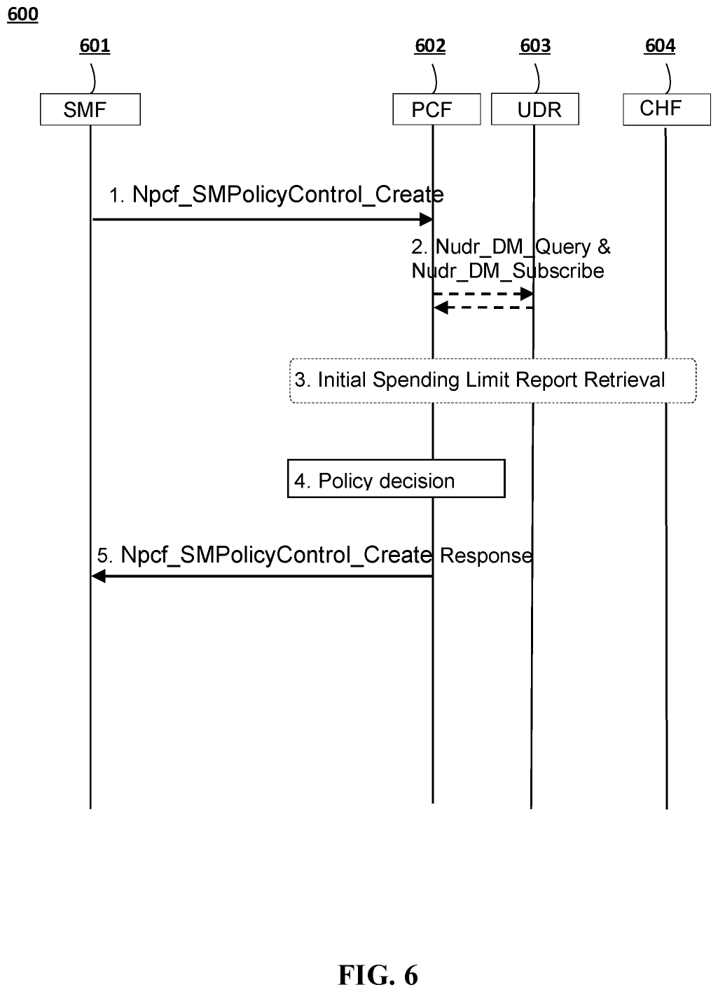

FIGS. 6-8 illustrate message flows and network configurations within which one or more of the above described one or more PCRs can be implemented, such as by PCF 114 for SMF 108. These message flows and network configurations are understood to be illustrative embodiments. As mentioned above, in some embodiments, these message flows may be used by a network entity, such as PCF 114, to configure SMF 108 with one or more PCRs.

FIG. 6 illustrates a session management (SM) policy association establishment using SMF 601, PCF 602, UDR 603, and CHF 604. The SM policy association establishment may be applied in both UE roaming and non-roaming scenarios. The SM policy association establishment may be used in UE requests for a PDU session establishment.

In operation 1 of the SM policy association establishment procedure flow, the SMF 601 determines the policy and charging control (PCC) authorization required to establish an SM policy association with PCF 602, such as by invoking Npcf_SMPolicyControl_Create service operation. In some embodiments, the message may comprise a data network name (DNN), DNN selection mode, IPv4 address, and IPv6 network prefix.

At operation 2, if the PCF 602 does not contain the subscription information associated with the PDU establishment request, PCF 602 may obtain subscription information from UDR 603, such as by invoking a Nudr_DM_Query service operation. The message may request the subscription information from UDR 403. In some example embodiments, the PCF 602 may request notifications from the UDR 603 regarding changes in subscription information, such as by invoking a Nudr_DM_Subscribe service operation.

At operation 3, the PCF 602 may determine the policy decision depending on the status of policy counters available CHF 604. At operation 4, the PCF 602 may make an authorization and policy decision. In some embodiments, the PCF 602 may reject the Npcf_SMPolicyControl_Create request when a validation condition is not satisfied.

At operation 5, the PCF 602 may respond to the SMF 601, such as by invoking a Npcf_SMPolicyControl_Create response. In some example embodiments, the PCF 602 may provide policy information in the message to SMF 601. This policy information may indicate the potential need to perform traffic offloading in the PDU Session and thus the need to insert an EASDF in the signaling path of DNS requests from the UE. When the SMF determines the need to insert an EASDF in the signaling path of DNS request from the UE, the SMF may decide to provide to a UPF) one of more PFCP Rules aiming at detecting whether the UE is sending its DNS requests to the EASDF.

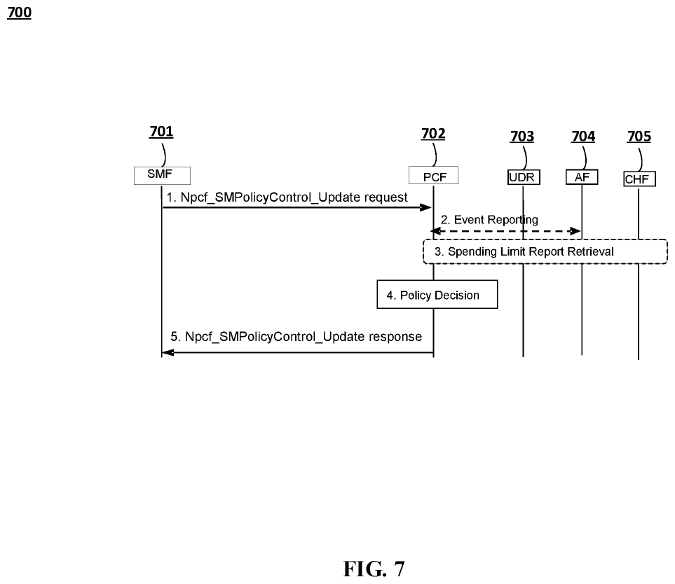

FIG. 7 illustrates an SMF initiated SM policy association modification using SMF 701, PCF 702, UDR 703, AF 704, and CHF 705. The SM policy association modification may be applied in both UE roaming and non-roaming scenarios. The SM policy association modification may be initiated by an SMF if a policy control request trigger is satisfied. The policy control request trigger may be a condition requiring the SMF to interact with PCF 702 for a policy

In operation 1 of the SMF initiated SM policy association modification procedure flow, the SMF 701 requests to update the SM policy association and provides information that a policy control request trigger condition has been met, such as by invoking a Npcf_SMPolicyControl_Update service operation. In operation 2, PCF 702 may report the event to an AF 704 that is subscribed to the event, such as by invoking the Npcf_PolicyAuthorization_Notify service operation. In some embodiments, the AF may provide a port management information container, MAC address reported for the PDU session, and a related port number in response. In operation 3, the PCF 702 may determine a change to the policy counter status and may alter the subscribed list of policy counters. In operation 4, the PCF 702 may determine a policy decision. In some embodiments, PCF 702 may determine to update policy information or generate new policy information for SMF 701.

In operation 5, the PCF 702 may respond to the SMF 701, such as by invoking a Npcf_SMPolicyControl_Update service operation. In some embodiments, the PCF 702 may provide policy information to the SMF. This policy information may indicate the potential need to perform traffic offloading in the PDU Session and thus, the need to insert an EASDF in the signaling path of DNS requests from the UE. When the SMF determines the need to insert an EASDF in the signaling path of DNS requests from the UE, the SMF may decide to provide to a UPF one of more PFCP Rules aiming at detecting whether the UE is sending its DNS requests to the EASDF.

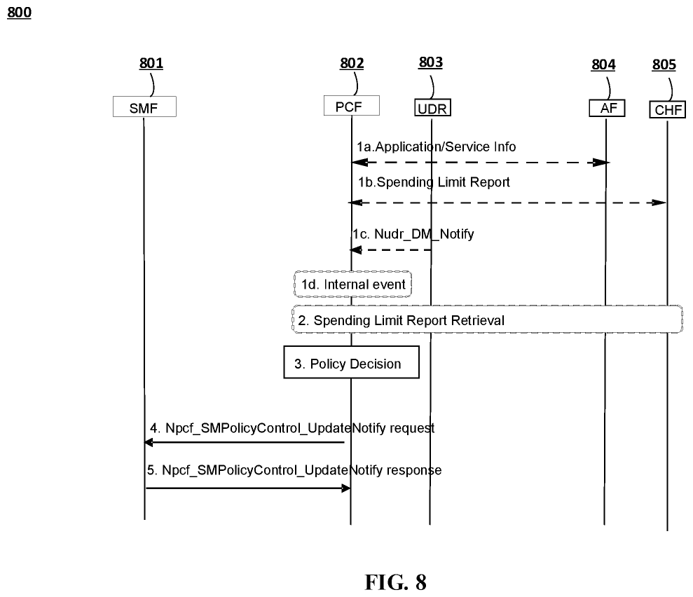

FIG. 8 illustrates a PCF initiated SM policy association modification using SMF 701, PCF 802, UDR 803, AF 804, and CHF 805. The SM policy association modification may be applied in both UE roaming and non-roaming scenarios. The SM policy association modification may be initiated by the PCF 802 based at least in part on a local decision or may be triggered by associated peers of the PCF 802, such as the UDR 803, AF 804, or CHF 805.

In operation 1a of the PCF initiated SM policy association modification procedure flow, the AF 804 may provide or revoke service information to the PCF 802, such as by invoking a Npcf_PolicyAuthorization_Create request or Npcf_PolicyAuthorization_Update request service operation. In operation 1b, the CHF 805 may provide a spending limit report to the PCF 802. In operation 1c, the UDR 803 may provide the PCF 802 with information about a policy subscription changes, such as by invoking a Nudr_DM_Notify service operation. In operations 1a-1c, the PCF 802 may also provide a response to the notifying network entity (e.g., UDR 803, AF 804, or CHF 805). At operation 1d, an internal event of the PCF 802 may occur, such as a timer or local decision.

At operation 2, the PCF 802 may determine a change to a policy counter status reporting. At operation 3, the PCF 802 may determine a policy decision. In some embodiments, PCF 802 may determine to update policy information or generate new policy information for SMF 801.

In operation 4, the PCF 602 may provide update policy information to SMF 801, such as by invoking a Npcf_SMPolicyControl_UpdateNotify request. In some embodiments, the PCF 802 may provide policy information in the message to SMF. This policy information may indicate the potential need to perform traffic offloading in the PDU Session and thus, the need to insert an EASDF in the signaling path of DNS requests from the UE. When the SMF determines the need to insert an EASDF in the signaling path of DNS requests from the UE, the SMF may decide to provide to a UPF, one of more PFCP Rules aiming at detecting whether the UE is sending its DNS requests to the EASDF.

In operation 5, the SMF 801 may provide an acknowledgement of the PCF 802 request, such as by invoking a Npcf_SMPolicyControl_UpdateNotify response. In some embodiments, if SMF 802 receives the request from a new PCF 802 instance, the SMF 801 may store the SM policy association towards the new PCF 802 instance.

FIGS. 3-8 illustrate flowcharts depicting methods according to an example embodiment of the present invention. It will be understood that each block of the flowcharts and combination of blocks in the flowcharts may be implemented by various means, such as hardware, firmware, processor, circuitry, and/or other communication devices associated with execution of software including one or more computer program instructions. For example, one or more of the procedures described above may be embodied by computer program instructions. In this regard, the computer program instructions which embody the procedures described above may be stored by a memory device 206 of an apparatus 200 employing an embodiment of the present invention and executed by a processor 202. As will be appreciated, any such computer program instructions may be loaded onto a computer or other programmable apparatus (for example, hardware) to produce a machine, such that the resulting computer or other programmable apparatus implements the functions specified in the flowchart blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart blocks.

Accordingly, blocks of the flowcharts support combinations of means for performing the specified functions and combinations of operations for performing the specified functions for performing the specified functions. It will also be understood that one or more blocks of the flowcharts, and combinations of blocks in the flowcharts, can be implemented by special purpose hardware-based computer systems which perform the specified functions, or combinations of special purpose hardware and computer instructions.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims.

Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

Although a few variations have been described in detail above, other modifications or additions are possible. In particular, further features and/or variations may be provided in addition to those set forth herein. Moreover, the implementations described above may be directed to various combinations and sub-combinations of the disclosed features and/or combinations and sub-combinations of several further features disclosed above. Other embodiments may be within the scope of the following claims.

If desired, the different functions discussed herein may be performed in a different order and/or concurrently with each other. Furthermore, if desired, one or more of the above-described functions may be optional or may be combined. Although various aspects of some of the embodiments are set out in the independent claims, other aspects of some of the embodiments comprise other combinations of features from the described embodiments and/or the dependent claims with the features of the independent claims, and not solely the combinations explicitly set out in the claims. It is also noted herein that while the above describes example embodiments, these descriptions should not be viewed in a limiting sense. Rather, there are several variations and modifications that may be made without departing from the scope of some of the embodiments as defined in the appended claims. Other embodiments may be within the scope of the following claims. The term “based on” includes “based on at least.” The use of the phase “such as” means “such as for example” unless otherwise indicated.

It should therefore again be emphasized that the various embodiments described herein are presented by way of illustrative example only and should not be construed as limiting the scope of the claims. For example, alternative embodiments can utilize different communication system configurations, user equipment configurations, base station configurations, identity request processes, messaging protocols and message formats than those described above in the context of the illustrative embodiments. These and numerous other alternative embodiments within the scope of the appended claims will be readily apparent to those skilled in the art.

That which is claimed:

1. A method comprising:
configuring a user plane function to detect whether a domain name system request sent by a user equipment satisfies one or more packet detection rules;
receiving, from the user plane function, a report that the domain name system request sent by the user equipment has been detected as non-compliant with instructions sent to the user equipment; and
causing one or more corrective actions relating to traffic offloading.

2. The method according to claim 1, wherein the received report from the user plane function comprises the domain name system request sent by the user equipment.

3. The method according to claim 1, wherein causing one or more corrective actions comprises inserting a local user plane function in a data path of a data session for the corresponding user equipment, wherein the local user plane function enforces the traffic offloading to an edge application server.

4. The method according to claim 3, wherein causing one or more corrective actions further comprises forwarding the domain name system request towards a domain name system server once the local user plane function has been inserted in the data path of a data session for the corresponding user equipment.

5. The method according to claim 1, wherein causing one or more corrective actions comprises forwarding the domain name system request towards an edge application server discovery function corresponding to the instructions sent to the user equipment.

6. The method according to claim 1, wherein configuring a user plane function to detect whether the domain name system request sent by the user equipment satisfies one or more packet detection rules comprises configuring the user plane function to compare one or more values provided by the domain name system request from the user equipment with one or more values associated with a network domain name system resolver assigned to the user equipment.

7. The method according to claim 6, wherein:
the one or more values provided by the domain name system request comprise a destination internet protocol address and a destination port, and
the one or more values associated with the network domain name system resolver comprise an internet protocol address.

8. The method according to claim 6, wherein:
the user plane function is configured to detect that the domain name system request sent by the user equipment does not comply with the instructions sent earlier to the user equipment by provisioning one packet detection rule to detect traffic matching domain name system requests sent to any internet protocol address other than an internet protocol address of the network domain name system resolver.

9. The method according to claim 6, wherein:
the user plane function is configured to detect that the domain name system request sent by the user equipment does not comply with the instructions earlier sent to the user equipment by provisioning at least a first and second packet detection rule, wherein
the first packet detection rule, to be evaluated first by the user plane function, is set to detect traffic matching domain name system requests sent to an internet protocol address of the network domain name system resolver; and
the second packet detection rule, to be evaluated only if the packet does not match the first packet detection rule, is set to detect traffic matching domain name system requests sent to any internet protocol address.

10. The method according to claim 1, wherein the domain name server request identifies any fully qualified domain name.

11. The method according to claim 1, wherein the domain name server request identifies a fully qualified domain name matching some detection criteria.

12. An apparatus comprising:
at least one processor; and
at least one memory including computer program code,
the at least one memory and the computer program code configured to, with the at least one processor, cause the apparatus at least to perform:
configure a user plane function to detect whether a domain name system request sent by a user equipment satisfies one or more packet detection rules;
receive, from the user plane function, a report that the domain name system request sent by the user equipment has been detected as non-compliant with instructions sent to the user equipment; and
cause one or more corrective actions relating to traffic offloading.

13. The apparatus according to claim 12, wherein the received report from the user plane function comprises the domain name system request sent by the user equipment.

14. The apparatus according to claim 12, wherein causing one or more corrective actions comprises inserting a local user plane function in a data path of a data session for the corresponding user equipment, wherein the local user plane function enforces the traffic offloading to an edge application server.

15. The apparatus according to claim 14, wherein causing one or more corrective actions further comprises forwarding the domain name system request towards a domain name system server once the local user plane function has been inserted in the data path of a data session for the corresponding user equipment.

16. The apparatus according to claim 12, wherein causing one or more corrective actions comprises forwarding the domain name system request towards an edge application server discovery function corresponding to the instructions sent to the user equipment.

17. The apparatus according to claim 12, wherein configuring a user plane function to detect whether the domain name system request sent by the user equipment satisfies one or more packet detection rules comprises configuring the user plane function to compare one or more values provided by the domain name system request from the user equipment with one or more values associated with a network domain name system resolver assigned to the user equipment.

18. The apparatus according to claim 17, wherein:
the user plane function is configured to detect that the domain name system request sent by the user equipment does not comply with the instructions sent earlier to the user equipment by provisioning one packet detection rule to detect traffic matching domain name system requests sent to any internet protocol address other than an internet protocol address of the network domain name system resolver.

19. The apparatus according to claim 17, wherein:
the user plane function is configured to detect that the domain name system request sent by the user equipment does not comply with the instructions earlier sent to the user equipment by provisioning at least a first and second packet detection rule, wherein
the first packet detection rule, to be evaluated first by the user plane function, is set to detect traffic matching domain name system requests sent to an internet protocol address of the network domain name system resolver; and
the second packet detection rule, to be evaluated only if the packet does not match the first packet detection rule, is set to detect traffic matching domain name system requests sent to any internet protocol address.

20. A computer program product comprises at least one non-transitory computer-readable storage medium having computer executable program code instructions stored therein, the computer executable program code instructions comprising program code instructions configured, upon execution, to:
configure a user plane function to detect whether the domain name system request sent by a user equipment satisfies one or more packet detection rules;
receive, from the user plane function, a report that a domain name system request sent by the user equipment has been detected as non-compliant with instructions sent to the user equipment; and
cause one or more corrective actions relating to traffic offloading.
